(19) United States
(12) Patent Application Publication
(10) Pub. No.: US 2026/0012546 A1
(43) Pub. Date: Jan. 8, 2026

(54) SCANNER WITH AUTOMATIC DOCUMENT FEEDING FUNCTION, SCAN DATA PRODUCTION METHOD, AND PRINTED MATTER PRODUCTION METHOD

(71) Applicant: SEIKO EPSON CORPORATION, TOKYO (JP)

(72) Inventor: Takeshi AOKI, SHIOJIRI-SHI (JP)

(21) Appl. No.: 19/179,040

(22) Filed: Apr. 15, 2025

(30) Foreign Application Priority Data
Apr. 15, 2024 (JP) 2024-065332

(51) Int. Cl. H04N 1/00

(52) U.S. Cl. CPC H04N 1/00782; H04N 1/00588; H04N 1/00708; H04N 1/00724

(57) ABSTRACT

A scanner with an automatic document feeding function includes a transport mechanism, a processor, and a scan sensor. The transport mechanism transports a medium stacked on a sheet feed section to a scanning position and ejects the medium after scanning. The processor controls the transport mechanism. The scan sensor scans the medium at the scanning position in a transport path. The processor determines a type of the medium transported by the transport mechanism. When the medium is a first medium of which a size in the transport direction is less than or equal to a threshold value, the processor performs control to delay feeding of a next medium, compared to when the medium is a second medium of which a size in the transport direction is greater than the threshold value and which is identical to the first medium except for the size.

The present application is based on, and claims priority from JP Application Serial Number 2024-065332, filed April 15, 2024, the disclosure of which is hereby incorporated by reference herein in its entirety.

### BACKGROUND

### 1. Technical Field

The present disclosure relates to a scanner with an automatic document feeding function, a scan data production method, and a printed matter production method.

### 2. Related Art

JP-A-2009-76967 discloses an image reading processing apparatus which aims to improve reading performance by shortening a gap between paper sheets and preventing an image from being lost when a document is skewed in continuous reading of documents.

However, according to the technique described in JP-A-2009-76967, although it is possible to increase the speed by shortening the gap between the paper sheets, an error such as a paper jam is more likely to occur.

Therefore, for a scanner with an automatic document feeding function, it is desirable to develop a technique for suppressing the occurrence of an error while increasing the speed by shortening a gap between paper sheets to be transported as necessary.

### SUMMARY

According to an aspect of the present disclosure, a scanner with an automatic document feeding function includes a transport mechanism that transports a medium stacked on a sheet feed section to a scanning position and ejects the medium after scanning, a processor that controls the transport mechanism, and a scan sensor that scans the medium at the scanning position in a transport path. The processor determines a type of the medium transported by the transport mechanism, and when the medium is a first medium of which a size in a transport direction of the medium is less than or equal to a threshold value, performs control to delay feeding of a next medium, compared to when the medium is a second medium of which a size in the transport direction is greater than the threshold value and which is identical to the first medium except for the size.

According to an aspect of the present disclosure, a scan data production method includes: continuously feeding a medium stacked on a sheet feed section; determining a type of the medium fed from the sheet feed section; delaying feeding of a next medium when the type of the medium is a first medium, compared to when the type of the medium is a second medium of which a size in a transport direction of the medium is larger than a size of the first medium in the transport direction and which is identical to the first medium except for the size; and producing scan data by scanning the medium continuously fed from the sheet feed section.

According to an aspect of the present disclosure, a printed matter production method includes: continuously feeding a medium stacked on a sheet feed section; determining a type of the medium fed from the sheet feed section; delaying feeding of a next medium when the type of the medium is a first medium, compared to when the type of the medium is a second medium of which a size in a transport direction of the medium is larger than a size of the first medium in the transport direction and which is identical to the first medium except for the size; and producing printed matter by performing printing on the medium continuously fed from the sheet feed section.

### BRIEF DESCRIPTION OF THE DRAWINGS

FIG. 1 is a block diagram illustrating an example of a configuration of a scanner according to an embodiment.

FIG. 2 is a schematic cross-sectional view illustrating an example of a configuration of the scanner illustrated in FIG. 1.

FIG. 3 is a diagram illustrating an example of a change in a distance between paper sheets according to each document size.

FIG. 4 is a flowchart for explaining an example of a scanning process in the scanner illustrated in FIG. 1.

FIG. 5 is a flowchart continued from FIG. 4.

FIG. 6 is a flowchart for explaining a scanning process in a scanner according to a comparative example.

FIG. 7 is a flowchart continued from FIG. 6.

FIG. 8 is a diagram illustrating an example of a hardware configuration of each of apparatuses.

### DESCRIPTION OF EMBODIMENTS

Hereinafter, embodiments of the present disclosure will be described with reference to the drawings. The drawings are merely examples for explaining the embodiments of the present disclosure. Furthermore, not all components described in the embodiments of the present disclosure are necessarily essential in the present disclosure.

### Embodiments

### Configuration of Scanner

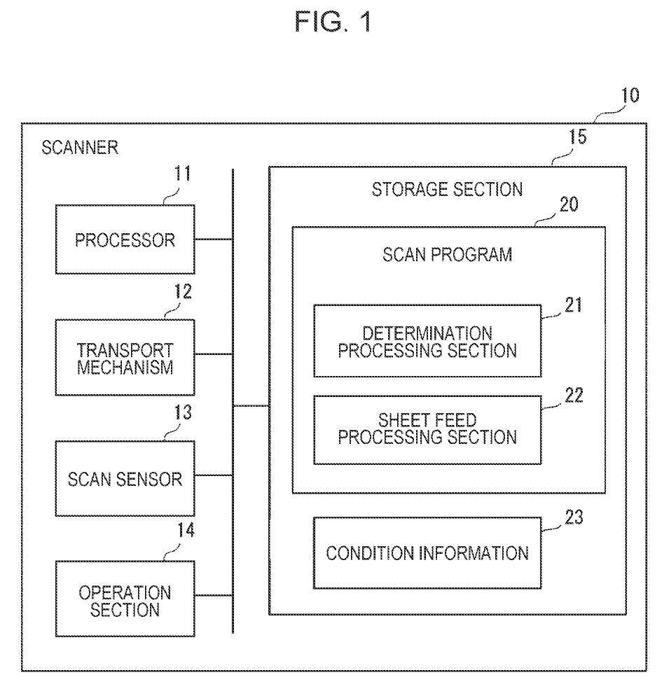

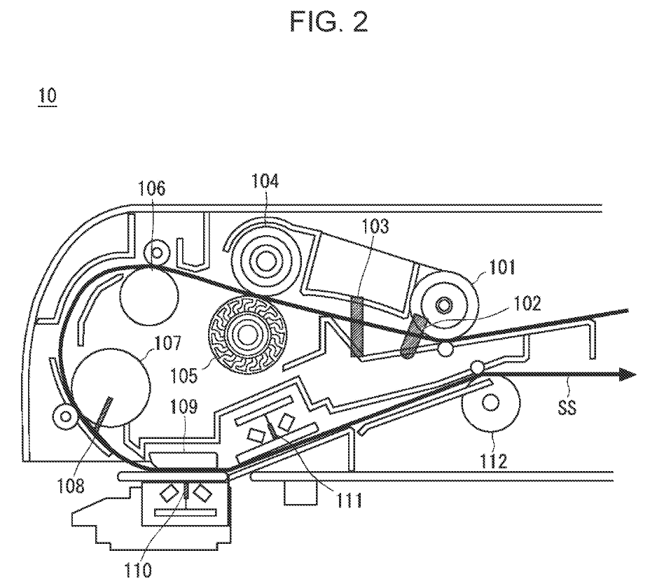

Hereinafter, an example of a configuration of a scanner according to the present embodiment will be described with reference to FIGS. 1 and 2. FIG. 1 is a block diagram illustrating the example of the configuration of the scanner according to the present embodiment. FIG. 2 is a schematic cross-sectional view illustrating the example of the configuration of the scanner illustrating in FIG. 1.

As illustrated in FIG. 1, the scanner 10 according to the present embodiment can include a processor 11, a transport mechanism 12, a scan sensor 13, an operation section 14, and a storage section 15.

The processor 11 controls the whole of the scanner 10. The processor 11 may include, for example, an arithmetic processing device, a working memory, and a storage device that stores a control program, parameters, and the like. The arithmetic processing device may be a central processing unit (CPU), a graphics processing unit (GPU), or the like. The processor 11 may also be configured as a system on a chip (SoC). As can be seen from these examples, the processor 11 may be configured to store the control program in an executable state. However, the processor 11 may be configured to store a portion of the control program as a circuit configuration such as a field-programmable gate array (FPGA) or may be configured as a dedicated circuit.

The control program may include a program for the arithmetic processing device to execute image processing in cooperation with the storage section 15, the transport mechanism 12, the scan sensor 13, and the operation section 14. An example in which at least a portion of the control program is stored in the storage section 15 provided separately from the processor 11 will be described below, but the storage section 15 may be a portion of the storage device in the processor 11. That is, the storage section 15 can also be regarded as a portion of the processor 11.

The storage section 15 is, for example, a storage device such as a hard disk drive, a solid state drive, or another memory. In the storage section 15, as a portion of the control program, a scan program 20 (described later) is stored in a state of being executable by the processor 11. The storage section 15 can store various types of data. The various types of data may include, for example, image data obtained by scanning and processed by the scan program 20, other intermediate data, and data of a file as a product.

The transport mechanism 12 transports a medium stacked on a sheet feed section to a scanning position and ejects the medium after scanning. Therefore, the transport mechanism 12 includes the sheet feed section (not illustrated) on which a medium which is a document to be read is mounted, a sheet ejecting section (not illustrated) which ejects the document after reading, and a mechanism which transports the document between the sheet feed section and the sheet ejecting section.

The scan sensor 13 scans the document at the scanning position in a transport path. The scan sensor 13, for example, optically reads an image of the document mounted on a document table, acquires data of the image, and passes the data to the processor 11.

In addition, the scanner 10 may include an automatic document feeder (not illustrated) as a portion of the transport mechanism 12 in order to automatically transport a plurality of documents one by one to the scan sensor 13, that is, to a reading position on a document table or the like. The automatic document feeder is also referred to as an ADF. ADF is an abbreviation for Automatic Document Feeder. As described above, the scanner 10 according to the present embodiment has an automatic document feeding function of automatically transporting a plurality of documents one by one to the reading position on the document table or the like. Therefore, the scanner 10 with the automatic document feeding function according to the present embodiment can also be referred to as an ADF scanner. The scanner 10 can also be referred to as a document reading apparatus.

An example of the transport mechanism 12 and an example of arrangement of the scan sensor 13 will be described with reference to FIG. 2. The transport mechanism 12 includes a pickup roller 101, a document detection sensor 102, a document stopper 103, a roller pair of a separation roller 104 and a retard roller 105, an intermediate roller 106, and a sheet feed roller 107 which are arranged along the document transport path SS. Although not illustrated, the transport mechanism 12 may include a motor for driving a drive roller, such as a sheet feed motor.

Furthermore, the transport mechanism 12 includes a trailing edge detection sensor 108, a pressing plate 109, and a sheet ejection roller 112 which are arranged along the document transport path SS on the downstream side of the sheet feed roller 107. As an example of the scan sensor 13, a front surface reading sensor 110 is disposed at a position facing the pressing plate 109, and a back surface reading sensor 111 is disposed between the front surface reading sensor 110 and the sheet ejection roller 112.

In FIG. 2, as indicated by an arrow which indicates the document transport path SS, transport of a document detected by the document detection sensor 102 is started when the pickup roller 101 picks up the document, and the document is separated from a next document by the separation roller 104. Thereafter, the document passes through the intermediate roller 106 and the sheet feed roller 107, and the leading edge of the document reaches the trailing edge detection sensor 108. When the document reaches the trailing edge detection sensor 108, the trailing edge detection sensor 108 is turned on, and when the trailing edge of the document is transported away from the trailing edge detection sensor 108, the trailing edge detection sensor 108 is turned off. The document detected by the trailing edge detection sensor 108 passes through document reading positions of the front surface reading sensor 110 and the back surface reading sensor 111, and is ejected from the sheet ejection roller 112.

The operation section 14 accepts an operation by a user of the scanner 10, and can also be referred to as an operation accepting section. The scanner 10 can also include a display section (not illustrated). The display section is a section for displaying a user interface (UI) image for operating the scanner 10, and is configured by a display device such as a liquid crystal display or an organic electroluminescence display. Note that the display section may include a display and a driver circuit for driving the display.

The operation section 14 can be implemented by, for example, a physical button, a touch panel mounted on the display section, or the like. In a configuration in which the operation section 14 includes a touch panel, the display section and the touch panel can be collectively referred to as an operation panel of the scanner 10.

The scanner 10 may include a communication section instead of the operation section 14 or in addition to the operation section 14. In this case, the scanner 10 can receive a signal indicating a user operation from an external apparatus via the communication section. Examples of the external apparatus include a terminal apparatus and a printer.

The terminal apparatus is, for example, an information processing apparatus having a communication function, such as a personal computer (PC), a smartphone, or a tablet terminal, and can be used by a user who desires image processing such as scanning of a document. When the external apparatus is a terminal apparatus, the scanner 10 can be coupled to the terminal apparatus via a wired or wireless network. The network may be, for example, a local area network. When the external apparatus is a printer, the printer and the scanner 10 can be configured as a copying machine or a multifunction peripheral having other functions.

The scan program 20 will be described. The scan program 20 may include a determination processing section 21 and a sheet feed processing section 22 in order to execute a process of transporting a document to be read to the position of the scan sensor 13 by the transport mechanism 12 and the scan sensor 13 and causing the scan sensor 13 to scan the document. The scan program 20 causes a computer to execute each process described as a process performed by each of the determination processing section 21 and the sheet feed processing section 22.

The determination processing section 21 performs a process of determining the type of a medium transported by the transport mechanism 12. The type of the medium includes at least the size of the medium in a transport direction of the medium, and may also include the thickness of the medium, the quality of the medium such as plain paper or a photo paper sheet, and the like. When the medium is a first medium of which a size in the transport direction is less than or equal to a threshold value, the sheet feed processing section 22 performs control to delay feeding of a next medium, compared to when the medium is a second medium of which a size in the transport direction is greater than the threshold value and which is identical to the first medium except for the size. The feeding of the next medium refers to feeding of the medium that is mounted on the sheet feed section and is to be transported next. In this way, the processor 11 performs control to determine the type of the medium and to delay the feeding of the next medium.

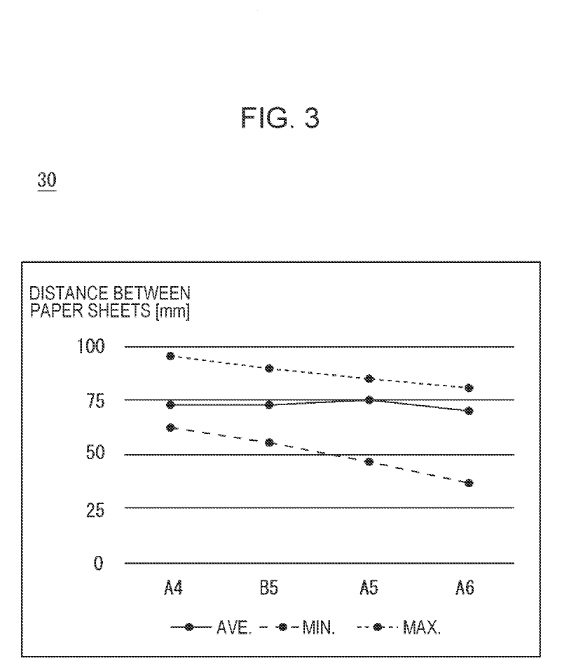

The reason why the control is performed will be described with reference to FIG. 3. This is mainly due to a difference in automatic document feeding performance for each document size. FIG. 3 is a diagram illustrating an example of a change in a distance between paper sheets according to each document size.

A graph 30 illustrated in FIG. 3 indicates results of distances between paper sheets when 100 paper sheets of documents of each of A4 size, B5 size, A5 size, and A6 size are continuously fed and read using the automatic document feeder. It can be seen that average values of the distances between the paper sheets of all the document sizes differ little from each other, but the distances between the paper sheets tend to be shorter for documents having a shorter length in the transport direction. Furthermore, from the results, it can be estimated that the frequency of occurrence of document jams increases when documents of A6 size are continuously fed and read.

As described above, a difference in document feeding performance for each document size becomes remarkable as the document feeding speed at the time of document reading is increased, and when documents having a short length in the transport direction are continuously fed and read, a distance between paper sheets cannot be secured. As described above, since the distance between paper sheets is short when continuous sheet feeding is performed in a state where the separation of a paper sheet from the next document is insufficient, it is estimated that a document is fed into the document transport path in a state where the separation of the paper sheet from the next document is insufficient when documents having a short length in the transport direction are continuously fed.

In order to avoid such a problem, in the sheet feed processing section 22, in accordance with the length of a document transported during document reading, a condition for feeding a subsequent document is switched to delay feeding of the next paper sheet, thereby reducing the possibility that sheet separation is not performed well when the document is short. Specifically, for the first medium of which the size in the transport direction of the medium is less than or equal to the threshold value, the sheet feed processing section 22 performs control to delay the feeding of the next medium, compared to the second medium of which the size in the transport direction of the medium is greater than the threshold value and is identical to the first medium except for the size. By such control, even when documents having a short length in the transport direction are continuously fed, the documents are fed into the document transport path SS in a state where the documents are sufficiently separated from the next documents, and it is possible to reduce the frequency of occurrence of an error such as a document jam.

### Example of Scanning Process

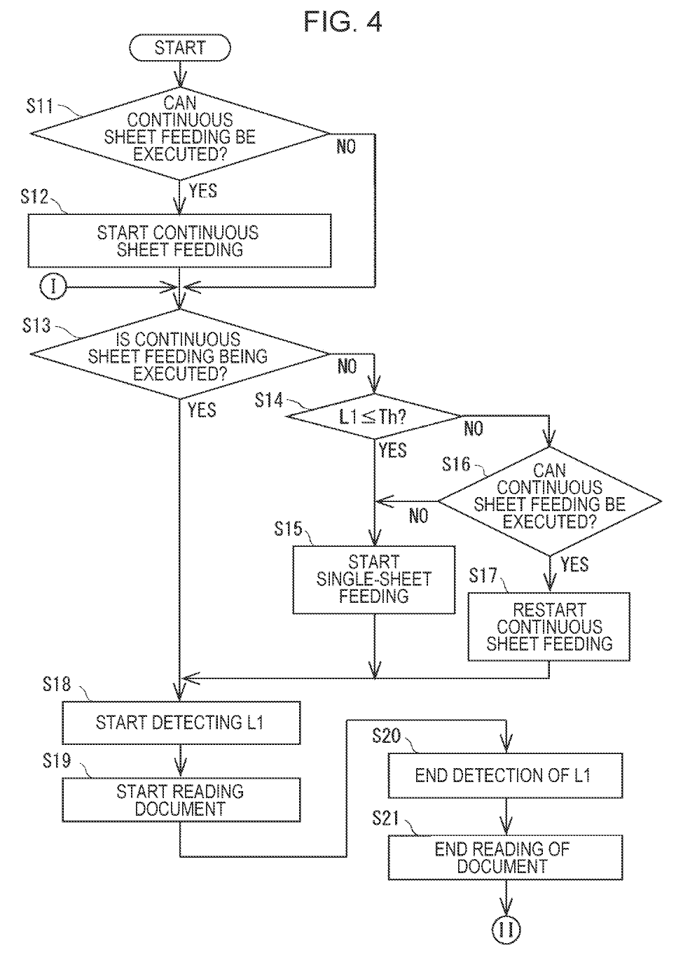

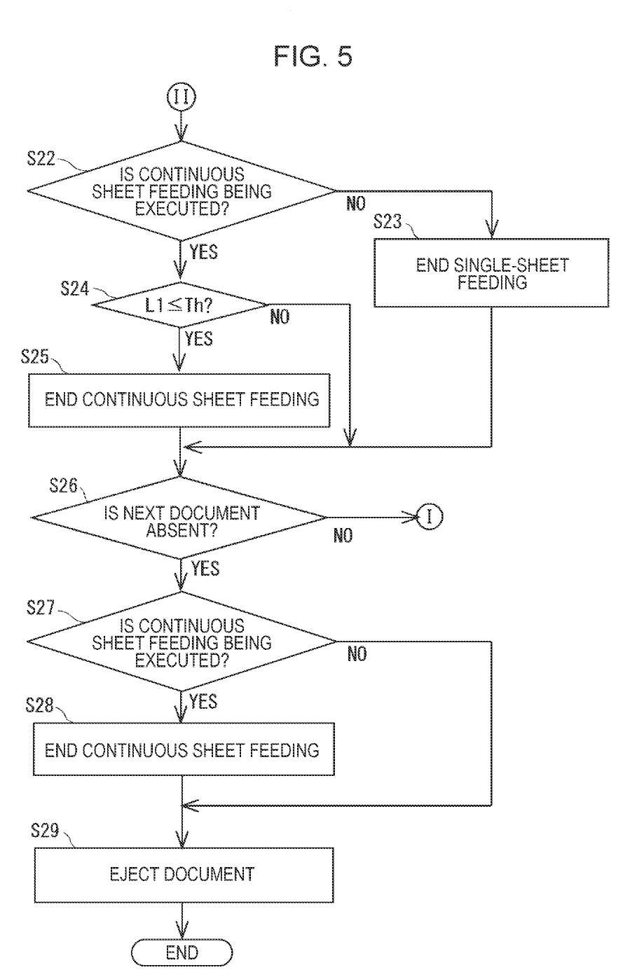

Next, an example of a scanning process including the above-described control in the scanner 10 will be described with reference to FIGS. 4 and 5. FIG. 4 is a flowchart for explaining the example of the scanning process in the scanner 10 illustrated in FIG. 1. FIG. 5 is a flowchart continued from FIG. 4.

In the scanner 10, condition information 23 is stored in the storage section 15 by a user operation on the operation section 14 or by default setting. The condition information 23 includes information indicating whether to execute mixed-size scanning in which a plurality of types of documents in terms of size are stacked on the sheet feed section in a mixed manner and scanned, or to execute non-mixed-size scanning in which one type of a document is stacked on the sheet feed section and scanned. The processor 11 refers to the condition information 23 to determine whether to execute the mixed-size scanning or the non-mixed-size scanning.

In the present embodiment, an example in which the mixed-size scanning is executed will be described below because the present embodiment is useful particularly when the mixed-size scanning is executed. That is, in the present embodiment, the scanner 10 is particularly useful when the scanner 10 has a mixed-size mounting function of enabling media of different sizes to be mounted on the sheet feed section in a mixed manner. In the mixed-size scanning, it is assumed that a plurality of types of documents that match the width of a guide that defines a width direction perpendicular to the document transport direction and that is provided in the sheet feed section are mounted in a mixed manner in a longitudinal or lateral orientation. Information indicating the width of the guide can be received by the processor 11 from a sensor installed in the guide.

For example, a case where an A4 size paper sheet mounted in the longitudinal orientation and an A5 size paper sheet mounted in the lateral orientation are mixed and stacked, a case where an A3 size paper sheet mounted in the longitudinal orientation and an A4 size paper sheet mounted in the lateral orientation are mixed and stacked, and a case where an A5 size paper sheet mounted in the longitudinal orientation and an A6 size paper sheet mounted in the lateral orientation are mixed and stacked are exemplified. In addition, for example, a case where a B3 size paper sheet mounted in the longitudinal orientation and a B4 size paper sheet mounted in the lateral orientation are mixed and stacked, a case where a B4 size paper sheet mounted in the longitudinal orientation and a B5 size paper sheet mounted in the lateral orientation are mixed and stacked, a case where a B5 size paper sheet mounted in the longitudinal orientation and a B6 size paper sheet mounted in the lateral orientation are mixed and stacked, and the like are exemplified. Of course, even if a document of another size which does not match the width of the guide is mounted, there is no problem as long as the document can be accurately transported by the transport mechanism 12 without being inclined.

In addition, the condition information 23 includes information indicating the above-described threshold value during mixed-size scanning and information indicating a document feeding condition indicating continuous sheet feeding or single-sheet feeding.

A description will be given of a case where a first condition, which is a document feeding condition determined before the start of document reading, is continuous sheet feeding in mixed-size scanning. When a length L1 of a document transported during the reading of documents by the continuous sheet feeding is less than or equal to a threshold value Th, the sheet feed processing section 22 ends the continuous sheet feeding, switches a second condition, which is a condition for feeding a subsequent document, to the single-sheet feeding, and causes the documents to be read. Thereafter, when a length L1 of a document transported during the reading of documents by the single-sheet feeding is not less than or equal to the threshold value Th, the sheet feed processing section 22 performs the following processing. That is, in this case, the sheet feed processing section 22 switches a condition for feeding a further subsequent document to the continuous sheet feeding which is the same document feeding condition as the first condition determined before the start of the document reading, and causes the document to be read. Of course, a determination as to whether or not a length of a document is less than or equal to the threshold value Th has the same meaning as a determination as to whether or not a length of a document is less than the threshold value.

Each length L1 can be detected as follows. As described with respect to the document transport path SS, when the leading edge of a document reaches the trailing edge detection sensor 108, the trailing edge detection sensor 108 is turned on, and when the trailing edge of the document is transported away from the trailing edge detection sensor 108, the trailing edge detection sensor 108 is turned off. Therefore, it is possible to detect a length L1 of the transported document from the amount of the document transported from when the trailing edge detection sensor 108 is turned on to when the trailing edge detection sensor 108 is turned off.

As a procedure of the processing, first, the sheet feed processing section 22 determines whether or not the continuous sheet feeding can be executed (step S11). This determination may be, for example, a determination as to whether or not the document detection sensor 102 can detect the presence of a plurality of documents in the sheet feed section and whether or not there is no paper jam error at present. If the result of step S11 is YES, the sheet feed processing section 22 instructs the transport mechanism 12 to start the continuous sheet feeding, and causes the transport mechanism 12 to start the continuous sheet feeding (step S12). If the result of step S11 is NO and after the processing in step S12, the sheet feed processing section 22 determines whether or not the continuous sheet feeding is being executed (step S13).

If the result of step S13 is NO, the determination processing section 21 determines whether or not L1 ≤ Th is satisfied, and passes the result of the determination to the sheet feed processing section 22 (step S14). If the result of step S14 is YES, the sheet feed processing section 22 switches the feeding to the single-sheet feeding, instructs the transport mechanism 12 to start the single-sheet feeding, and causes the transport mechanism 12 to start the single-sheet feeding (step S15). If the result of step S14 is NO, including a case where L1 is not detected, the sheet feed processing section 22 determines whether or not the continuous sheet feeding can be executed, as in step S11 (step S16). If the result of step S16 is NO, the process advances to step S15, and the single-sheet feeding is started. If the result of step S16 is YES, the sheet feed processing section 22 instructs the transport mechanism 12 to restart the continuous sheet feeding, and causes the transport mechanism 12 to restart the continuous sheet feeding (step S17).

If the result of step S13 is YES, after the processing in step S15 and after the processing in step S17, the sheet feed processing section 22 instructs the trailing edge detection sensor 108 to start detecting a length L1, and causes the trailing edge detection sensor 108 to start detecting the length L1 (step S18). After step S18, the sheet feed processing section 22 instructs the front surface reading sensor 110 and the back surface reading sensor 111 to start reading a document, and causes the front surface reading sensor 110 and the back surface reading sensor 111 to start reading the document (step S19). Thereafter, as the document is transported, the detection of the length L1 by the trailing edge detection sensor 108 ends (step S20), and the reading of the document also ends (step S21).

Next, the sheet feed processing section 22 determines whether or not the continuous sheet feeding is being executed (step S22). If the result of step S22 is NO, the sheet feed processing section 22 transmits, to the transport mechanism 12, an instruction to end the single-sheet feeding, and causes the transport mechanism 12 to end the single-sheet feeding (step S23). If the result of step S22 is YES, the determination processing section 21 determines whether or not L1 ≤ Th is satisfied, and passes the result of the determination to the sheet feed processing section 22 (step S24). If the result of step S24 is YES, the sheet feed processing section 22 instructs the transport mechanism 12 to end the continuous sheet feeding, and causes the transport mechanism 12 to end the continuous sheet feeding (step S25). After the processing in step S25, if the result of step S24 is NO and after the processing in step S22, the sheet feed processing section 22 determines whether or not a next document is absent, based on a result of detection by the document detection sensor 102 (step S26).

If the next document is present, that is, if the result of step S26 is NO, the sheet feed processing section 22 returns to step S13 and continues the process. If the next document is absent, that is, if the result of step S26 is YES, since it is not necessary to process the next document, the sheet feed processing section 22 determines whether or not the continuous sheet feeding is being executed (step S27). If the result of step S27 is YES, the sheet feed processing section 22 instructs the transport mechanism 12 to end the continuous sheet feeding, and causes the transport mechanism 12 to end the continuous sheet feeding (step S28). After the processing in step S28, if the result of step S27 is NO, the sheet feed processing section 22 instructs the sheet ejection roller 112 or the like to eject the document, causes the sheet ejection roller 112 or the like to eject the document (step S29), and ends the process.

As described above, in the scanning process in the mixed-size scanning, the document feeding condition determined before the start of reading of a document is switched to a condition for feeding a subsequent document, based on the length L1 of the document transported during the reading of the document, and the document is read. That is, in the scanning process in the mixed-size scanning, the document feeding condition is switched to the condition for feeding the subsequent document, based on the length L1 of the document transported during the reading of the document under the pre-start condition determined before the start of the reading of the document. Furthermore, in this scanning process, based on the length of the document transported during the reading of the document under the document feeding condition after the switching, the condition for feeding the subsequent document is switched to the pre-start condition and the document is read.

In addition, as described above, when the transported document is the first medium, the processor 11 performs control to delay the feeding of the next medium, compared to when the transported document is the second medium. This control may be more simplified control. That is, when the type of the document is the second medium, that is, L1 > Th, the processor 11 may perform control such that the feeding of the next medium is started before the ejection of the document is completed. In other words, when L1 > Th, the sheet feed processing section 22 may control the transport mechanism 12 so as to start feeding the next document before the ejection of the document is completed. This is because, when documents are long in the transport direction, the distance between the paper sheets tends to be longer than when the documents are short in the transport direction, and thus it is considered that a problem such as a paper jam is less likely to occur even if the feeding of the next document is started before the completion of the ejection.

In this case, when the type of the document is the first medium, that is, L1 ≤ Th, the processor 11 may perform control such that the feeding of the next document is started after the ejection of the document is completed. That is, when L1 ≤ Th, the sheet feed processing section 22 may control the transport mechanism 12 so as to start feeding the next document after the ejection of the document is completed. This is because, when the type of documents is a short medium in the transport direction, the distance between paper sheets tends to be shorter than when the type of documents is a long medium in the transport direction, and therefore, it is considered that there is a possibility that a problem such as a paper jam may occur unless the feeding of the next document is started after the completion of the ejection.

In addition, as exemplified by using the trailing edge detection sensor 108 in FIG. 2, a medium detection sensor which detects a medium which is a document may be provided on the upstream side of the front surface reading sensor 110 and the rear surface reading sensor 111 which are examples of the scan sensor. Then, the processor 11 may determine the size of the document in the transport direction based on output of the medium detection sensor.

In addition, as described above, when the transported document is the first medium, the processor 11 performs control to delay the feeding of the next medium, compared to when the transported document is the second medium. This control may be simplified by controlling the timing of the start of sheet feeding. That is, the processor 11 may set a time interval between the start of feeding of the transported document and the start of feeding of the next document to be shorter when the transported document is the second medium than when the transported document is the first medium. This is because, when the type of transported documents is a long medium in the transport direction, the distance between the paper sheets tends to be longer than when the type of transported documents is a short medium, and thus it is considered that a problem such as a paper jam is less likely to occur even when a period of time until the start of the feeding of the next document is shortened. In this case, the start of feeding of each document may indicate a time point at which the document is separated from the next document by the separation roller 104 and starts to be transported by the intermediate roller 106.

### Scanning Process According to Comparative Example

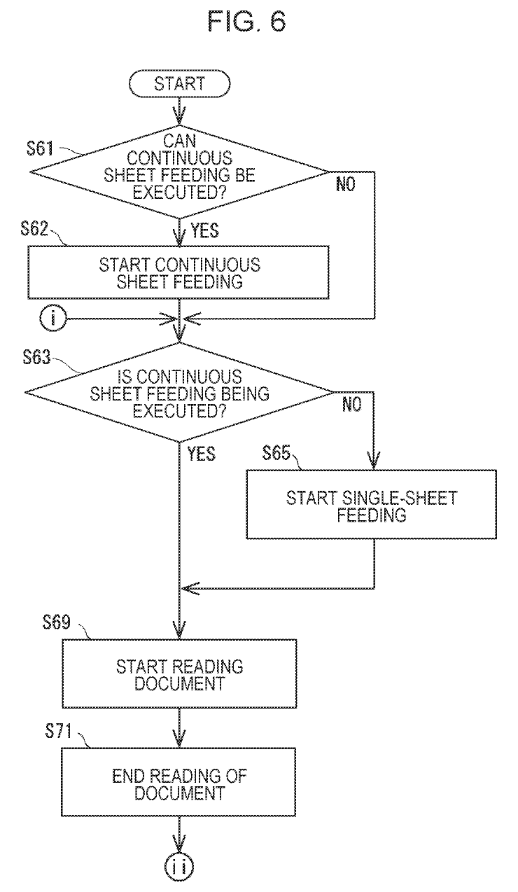

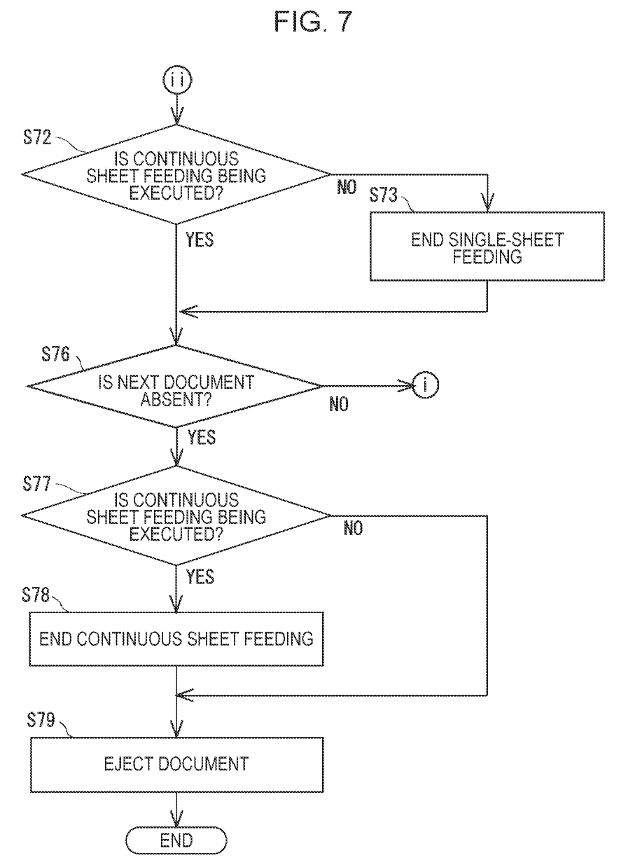

Before description of effects of the present embodiment, a scanning process that is performed by a scanner according to a comparative example will be described with reference to FIGS. 6 and 7. FIG. 6 is a flowchart for explaining the scanning process in the scanner according to the comparative example. FIG. 7 is a flowchart continued from FIG. 6.

Unlike the present embodiment, the scanning process according to the comparative example does not include the determination based on the length of a document as in step S14 and S24. The scanner according to the comparative example is hereinafter referred to as a comparative scanner, and components corresponding to those illustrated in FIG. 2 will be described as components having the same names as those illustrated in FIG. 2.

As a procedure of the process according to the comparative example, first, similarly to step S11, the comparative scanner determines whether or not continuous sheet feeding can be executed (step S61). If the result of step S61 is YES, the comparative scanner instructs a transport mechanism to start the continuous sheet feeding, and causes the transport mechanism to start the continuous sheet feeding (step S62). If the result of step S61 is NO, and after the processing in step S62, the comparative scanner determines whether or not the continuous sheet feeding is being executed (step S63).

If the result of step S63 is NO, the comparative scanner switches the feeding to single-sheet feeding, instructs the transport mechanism to start the single-sheet feeding, and causes the transport mechanism to start the single-sheet feeding (step S65). If the result of step S63 is YES, and after the processing in step S65, the comparative scanner instructs a front surface reading sensor and a back surface reading sensor to start reading a document, and causes the front surface reading sensor and the back surface reading sensor to start reading the document (step S69). Thereafter, as the document is transported, the reading of the document ends (step S71).

Next, the comparative scanner determines whether or not the continuous sheet feeding is being executed (step S72). If the result of step S72 is NO, the comparative scanner transmits, to the transport mechanism, an instruction to end the single-sheet feeding, and causes the transport mechanism to end the single-sheet feeding (step S73). If the result of step S72 is YES and after the processing in step S73, the comparative scanner determines whether or not a next document is absent, based on a result of detection by a document detection sensor (step S76).

If the next document is present, that is, if the result of step S76 is NO, the comparative scanner returns to step S63 and continues the process. If the next document is absent, that is, if the result of step S76 is YES, since it is not necessary to process the next document, the comparative scanner determines whether or not the continuous sheet feeding is being executed (step S77). If the result of step S77 is YES, the comparative scanner instructs the transport mechanism to end the continuous sheet feeding, and causes the transport mechanism to end the continuous sheet feeding (step S78). After the processing in step S78, and if the result of step S77 is NO, the comparative scanner instructs a sheet ejection roller or the like to eject the document (step S79), and ends the process.

In the comparative example, a document feeding condition is determined before the reading of a document is started, and the document feeding condition is not switched during the reading of the document. Therefore, in the comparative example, a difference in document feeding performance for each document size becomes remarkable as the document feeding speed at the time of reading a document is increased, and a distance between paper sheets cannot be secured when the documents having a short length in the transport direction are continuously fed and read. If a distance between paper sheets cannot be secured, the frequency of occurrence of a document jam increases. Therefore, in the comparative example, it is necessary to perform single-sheet feeding and document reading in which a distance between paper sheets can be secured even for a document having a short length in the transport direction.

As described above, in the comparative example, since feeding of documents having different lengths in the transport direction are targets during mixed-size scanning, as a document feeding condition determined before the start of document reading, it is necessary to perform single-sheet feeding in which a distance between paper sheets can be secured even for a document having a short length in the transport direction. Therefore, in the comparative example, it is necessary to read a document while performing the single-sheet feeding regardless of the length of the document in the transport direction, and a difference in speed performance from high-speed continuous feeding and document reading in non-mixed-size scanning increases.

That is, the mixed-size scanning is highly convenient for a user who handles documents having various lengths because the mixed-size scanning can be used without sorting documents in accordance with the lengths of the documents. However, in the comparative example, there is a problem in that the speed performance of the scanner cannot be sufficiently utilized.

### Effects of Present Embodiment

In the scanner 10 with the automatic document feeding function according to the present embodiment, by switching to a document feeding condition suitable for the length of a document transported during document reading, it is possible to perform high-speed continuous feeding and document reading that are the same as those in non-mixed-size scanning unless the document has a short length in the transport direction. In addition, in the scanner 10, for a document having a short length in the transport direction, in order to suppress the occurrence of a document jam, single-sheet feeding and document reading can be executed, and mixed-size scanning using the speed performance of the scanner can be executed. As described above, according to the present embodiment, unlike the comparative example, it is possible to make beneficial use of high convenience of the mixed-size scanning, and it is possible to suppress the occurrence of an error such as a paper jam while increasing the speed by shortening an interval between paper sheets to be transported as necessary.

### Scan Data Production Method According to Present Embodiment

As the present embodiment, the configuration of the scanner 10 has been mainly described. In the present embodiment, as described in the example of the process, a scan data production method can be provided. As the scan data production method, it is possible to provide a scan data production method including each of the processes described as the processes performed by the determination processing section 21 and the sheet feed processing section 22. In addition, in the scan data production method, a medium stacked on a sheet feed section is continuously fed, and the type of the medium fed from the sheet feed section is determined. In the scan data production method, when the type of the medium is a first medium, feeding of a next medium is delayed, compared to when the type of the medium is a second medium of which a size in a transport direction is larger than a size of the first medium in the transport direction and which is identical to the first medium except for the size. In the scan data production method, scan data is produced by scanning the medium continuously fed from the sheet feed section.

### Other Modifications

The present disclosure is not limited to the above-described embodiment, and can be appropriately modified without departing from the scope of the present disclosure. For example, the configuration of the scanner, the configuration of each of the programs included in the scanner, the process procedure of the scanner, and the like are not limited to those illustrated.

In addition, the control of the transport and the like according to the above-described embodiment in the production of the scan data can also be applied during the feeding of a medium to be printed.

That is, the present disclosure also includes a mode as a printed matter production method described below. In this printed matter production method, a medium stacked on a sheet feed section is continuously fed, and the type of the medium fed from the sheet feed section is determined. In this case, the sheet feed section is a portion for supplying a medium to be printed. In the printed matter production method, when the type of the medium is a first medium, feeding of a next medium is delayed, compared to when the type of the medium is a second medium of which a size in a transport direction is larger than a size of the first medium in the transport direction and which is identical to the first medium except for the size. In this printed matter production method, printed matter is produced by performing printing on the medium continuously fed from the sheet feed section. For example, when the printing is performed instead of scanning at the scanning position of the scanner 10, the printed matter can be produced. Although an example of a configuration of a printing apparatus that performs the printing and details of an example of a process by the printing apparatus are not described in detail, a general printing apparatus may be configured to control the sheet feeding as described for the scanner 10.

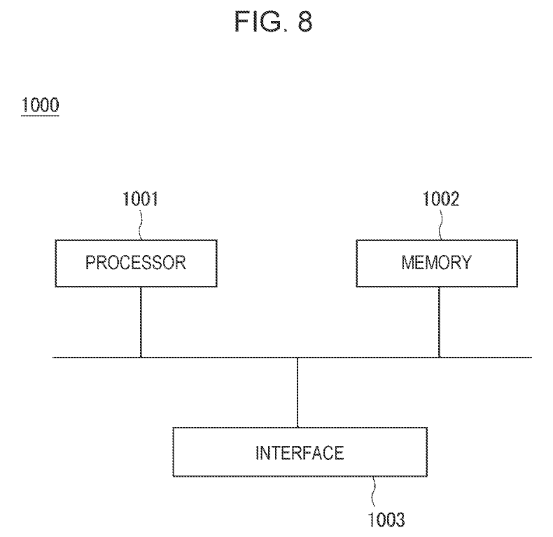

In addition, each of the apparatuses such as the scanner, the printing apparatus, and the external apparatus which can be coupled to the scanner or the printing apparatus according to the above-described embodiment can include, for example, the following hardware configuration. FIG. 8 is a diagram illustrating an example of the hardware configuration of each of the apparatuses.

An apparatus 1000 illustrated in FIG. 8 may include a processor 1001, a memory 1002, and an interface 1003. The interface 1003 may include, for example, a communication interface and an interface with an input/output device, which are necessary depending on the apparatus.

The processor 1001 may be, for example, a CPU, a GPU, or an MPU (microprocessor unit) also referred to as a microprocessor. The processor 1001 may include a plurality of processors. The memory 1002 is configured by, for example, a combination of a volatile memory and a nonvolatile memory. The functions in each of the apparatuses are implemented by the processor 1001 reading a program stored in the memory 1002 and executing the program while exchanging necessary information via the interface 1003.

In addition, the above-described program includes an instruction group (or software code) for causing a computer to perform one or more of the functions described in the embodiments when the program is read by the computer. The program may be stored in a non-transitory computer-readable medium or a tangible storage medium. By way of example, and not limitation, examples of the computer-readable medium or the tangible storage medium include a random-access memory (RAM), a read-only memory (ROM), a flash memory, a solid-state drive (SSD), or other memory technologies. Also by way of example, and not limitation, examples of the computer-readable medium or the tangible storage medium include a CD-ROM, a digital versatile disc (DVD), a Blu-ray (registered trademark) disc or other optical disc storage, a magnetic cassette, magnetic tape, magnetic disk storage or another magnetic storage device. The program may be transmitted on a transitory computer-readable medium or a communication medium. By way of example, and not limitation, examples of the transitory computer-readable medium or the communication medium includes electrical, optical, acoustical or other forms of propagated signals. Furthermore, the program is included in a program product.

Although the present disclosure has been described with reference to the above-described embodiments, the present disclosure is not limited to the configurations described in the above-described embodiments, and it goes without saying that the present disclosure includes various modifications, corrections, and combinations that can be made by those skilled in the art within the scope of the claims of the present application. For example, the scan data production method and the printed matter production method can also be regarded as a scanning method and a printing method, respectively.

What is claimed is:

1. A scanner with an automatic document feeding function comprising:
a transport mechanism that transports a medium stacked on a sheet feed section to a scanning position and ejects the medium after scanning;
a processor that controls the transport mechanism; and
a scan sensor that scans the medium at the scanning position in a transport path, wherein the processor determines a type of the medium transported by the transport mechanism, and
when the medium is a first medium of which a size in a transport direction of the medium is less than or equal to a threshold value, performs control to delay feeding of a next medium, compared to when the medium is a second medium of which a size in the transport direction is greater than the threshold
value and which is identical to the first medium except for the size.

2. The scanner with the automatic document feeding function according to claim 1, wherein whin the type of the medium is the second medium, the processor performs control to start the feeding of the next medium before ejection of the medium is completed.

3. The scanner with the automatic document feeding function according to claim 2, wherein whin the type of the medium is the first medium, the processor performs control to start the feeding of the next medium after the ejection of the medium is completed.

4. The scanner with the automatic document feeding function according to claim 1, further comprising:
a mixed-size mounting function of enabling media of different sizes to be mounted on the sheet feed section in a mixed manner.

5. The scanner with the automatic document feeding function according to claim 1, further comprising:
a medium detection sensor that is provided on an upstream side of the scan sensor and detects the medium, wherein the processor determines the size of the medium in the transport direction of the medium based on output of the medium detection sensor.

6. The scanner with the automatic document feeding function according to claim 1, wherein a time interval between start of feeding of the medium and start of the feeding of the next medium is shorter when the medium is the second medium than when the medium is the first medium.

7. A scan data production method comprising:
continuously feeding a medium stacked on a sheet feed section;
determining a type of the medium fed from the sheet feed section;
delaying feeding of a next medium when the type of the medium is a first medium, compared to when the type of the medium is a second medium of which a size in a transport direction is larger than a size of the first medium in the transport direction and which is identical to the first medium except for the size; and
producing scan data by scanning the medium continuously fed from the sheet feed section.

8. A printed matter production method comprising:
continuously feeding a medium stacked on a sheet feed section;
determining a type of the medium fed from the sheet feed section;
delaying feeding of a next medium when the type of the medium is a first medium, compared to when the type of the medium is a second medium of which a size in a transport direction is larger than a size of the first medium in the transport direction and which is identical to the first medium except for the size; and
producing printed matter by performing printing on the medium continuously fed from the sheet feed section.
